(19) United States
(12) Patent Application Publication
(10) Pub. No.: US 2003/0005138 A1
(43) Pub. Date: Jan. 2, 2003

(54) Wireless streaming audio system

(76) Inventors: Michael Shawn Giffin, Littleton, CO (US); Shuichi Takagi, Superior, CO (US)

Correspondence Address: MILLER PATENT SERVICES, 2500 DOCKERY LANE, RALEIGH, NC, 27606, US

(21) Appl. No.: 09/891,005

(22) Filed: Jun. 25, 2001

(51) Int. Cl. G06F 15/16; G06F 17/60

(52) U.S. Cl. 709/231; 705/26

(57) ABSTRACT

A wireless streaming audio system and method. A user subscribes to a service for storage of music files on a server at a data center. The music files may be uploaded from the user or obtained by the data center from a commercial music source. The user may play back the stored music at a wireless music player by requesting transmission of the music by the data center. The data center then provides a wireless transmission of streaming audio data to the music player for real time or near real time playback. The music player is freed of the need for local storage of music files and may be readily incorporated into a cellular telephone or other wireless communication device. In other embodiments, the music player may be implemented as a stand-alone music player device.

### FIELD OF THE INVENTION

This invention relates generally to the field of audio systems. More particularly, this invention relates to methods and apparatus for providing remote storage of audio files and wireless streaming audio playback.

### BACKGROUND OF THE INVENTION

Storage devices for storing electronic data such as music files have steadily decreased in size and cost while increasing in storage capacity over the years. Such devices as Compact Discs, and flash memory cards such as the Sony Memory Stick™ have made it possible to store high quality audio files for playback very conveniently by the user. However, it remains impractical for the user to take full advantage of a library of music using such storage mechanisms while remaining mobile. Even with the smallest and most dense storage media, a substantial library of music is impractical to carry around with the user. This is especially true if the user is traveling on foot, bicycle or using public transportation where storage space and convenience can become a major limitation to the amount of music that one can readily carry. This is particularly true if the user is carrying a music player along with a personal digital assistant, cellular telephone and other possessions.

### SUMMARY OF THE INVENTION

The present invention relates generally to audio systems. Objects, advantages and features of the invention will become apparent to those skilled in the art upon consideration of the following detailed description of the invention.

In certain embodiments consistent with the present invention a wireless streaming audio system and method is provided. A user subscribes to a service for storage of music files on a server at a data center. The music files may be uploaded from the user or obtained by the data center from a commercial music source. The user may play back the stored music at a wireless music player by requesting transmission of the music by the data center. The data center then provides a wireless transmission of streaming audio data to the music player for real time or near real time playback. The music player is freed of the need for local storage of music files and may be readily incorporated into a cellular telephone or other wireless communication device. In other embodiments, the music player may be implemented as a stand-alone music player device.

A method consistent with an embodiment of the invention, includes storing a music file for a user; receiving a request from the user for playback of the music file; and transmitting the music file to the user for playback, using wireless transmission, as a streaming music file. The method may further include receiving from the user a request to store the music file; and wherein the storing is carried out as a response to the request to store the music file.

An electronic storage medium storing instructions which, when executed on a programmed processor, carry out a method consistent with an embodiment of the invention including storing a music file for a user; receiving a request from the user for playback of the music file; and transmitting the music file to the user for playback, using wireless transmission, as a streaming music file.

A data center consistent with an embodiment of the invention includes a content server that stores music files for plurality of users. A request is received from the user for playback of the music file. The music file is transmitted to the user for playback, using wireless transmission, as a streaming music file. Preferably, the data center receives from the user a request to store the music file, and wherein the storing is carried out as a response to the request to store the music file.

A music player consistent with an embodiment of the invention includes a wireless receiver for receiving transmission of streaming data. A streaming audio decoder, coupled to the wireless receiver decodes the streaming data into analog audio signals. An audio circuit converts the analog audio signals into audible sounds. The music player may also have a user interface that receives user commands, and a wireless transmitter for transmitting the user commands to a data center to direct the data center to transmit the streaming data.

A method of operation of a wireless music player, consistent with an embodiment of the invention, includes receiving a user input for playback of a music selection; transmitting a request to a data center for the music selection; receiving a streaming data file representing the music selection; decoding the streaming data file to produce an audible representation of the music selection; and playing the audible representation of the music selection for the user.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a block diagram illustrating a system for remote storage of music files and wireless playback by streaming audio according to an embodiment consistent with the invention.

FIG. 2 is a flow chart illustrating a process consistent with an embodiment of the invention.

FIG. 3 is a block diagram of a music player consistent with an embodiment of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

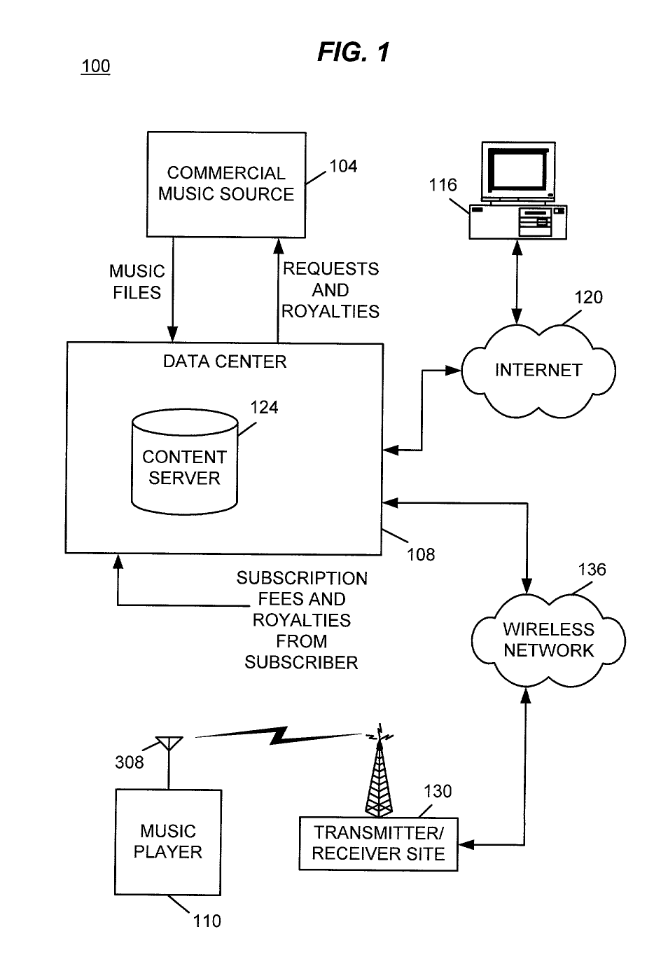

Turning now to FIG. 1, a block diagram of a system for remote storage of music files and wireless playback by streaming audio according to an embodiment consistent with the invention is shown as 100. In the embodiment illustrated, system 100 provides a customer with the ability to store personally owned music or music from a commercial music source 104 (e.g., a record company or recording artist) at a data center 108 for playback at a later time from any suitable location on a music player 110 using a wireless transmission of streaming audio. In accordance with this embodiment, a user may own rights to music (e.g., by purchase or by his or her own creation) that the user stores on electronic storage media within, or playable on, his or her personal computer system 116. In order to conveniently have access to this music, the user can utilize a wireless device incorporating a music player 110 (e.g., a dedicated personal music player, a PDA, a cellular telephone device or a multifunction device incorporating the music player).

In this embodiment, the customer (the terms “user”, “subscriber” and “customer” can be used somewhat interchangeably herein) subscribes to a service provided by the data center 108 for storage of his or her personal library of music. The customer (or approved users) can then upload music files for storage to the data center 108 via the Internet 120. At the data center 108, these music files are stored on a content server 124 for future access by the user.

When the user wishes to play back the music stored at content server 124, a request is sent to the data center, preferably by the music player 110 using wireless communication, through a nearby transmitter/receiver site 130 which may be coupled to the data center 108, for example, through a wireless data network 136 (which may include wired and wireless connections) such as a cellular telephone network or other similar infrastructure. When the data center 108 receives a valid request for playback, the content server 124 streams real time or near real time audio back to the user through the wireless network 136 and nearby transmitter/receiver site 130 to the music player 110. The music player may then play back the audio in real time or near real time, thus providing the user with access to this music at any location within range of an appropriate transmitter receiver site 130.

In another variation of the invention, the user may not only upload music from a personal library as just described for remote wireless access, but may also use the content server 124 at the data center 108 for storage of music files provided by a commercial music source 104 such as a record company. In this embodiment, the user requests that the data center 108 obtain and store a particular music selection. The data center 108 then requests the music from a suitable commercial music source 104 and obtains the files via an electronic transfer from the music source 104 for storage on content server 124. The data center 108 then pays royalties to the commercial music source 104 (or to a royalty agent) and passes along fees to cover the royalties on to the subscriber. Since the data center 108 may purchase rights to a particular selection for numerous subscribers, they may be able to obtain reduced royalty rates that can result in savings that may passed on to the subscriber. Also, since multiple users may wish access to a particular selection, the music selection need only be stored once in content server 124 with access to the selection mapped to users who contribute to the royalties (or are otherwise entitled to access the selection, e.g., by virtue of a flat rate subscription). Any number of fee structures can be devised for the implementation of various embodiments of the present invention.

The actions of the data center 108, as will be appreciated by those skilled in the art, are preferably implemented using a programmed processor forming a part of, or connected to, content server 124. The program steps for carrying out the data center 108 actions may by stored on any suitable electronic storage medium.

In accordance with the embodiment illustrated in FIG. 1, the transmitter/receiver site 130 may be part of a cellular telephone or other wireless telephone network (or a data network or other communication network) and the streaming audio may be provided by any suitable Wireless Application Protocol (WAP) that is able to support a suitable data rate for acceptable quality audio. However, other wireless communication arrangements can be used including blue tooth for use in smaller areas (e.g., a home network) or using a dedicated wireless network may be provided for distribution of the data. As will be seen later, the circuitry required to implement the present invention at the music player 110 may be a minimal addition to many existing electronic communication devices such as PDAs and cellular telephones, lending itself to easy incorporation into such devices to not only eliminate the need to carry a collection of stored music, but also to eliminate the need to carry a separate player.

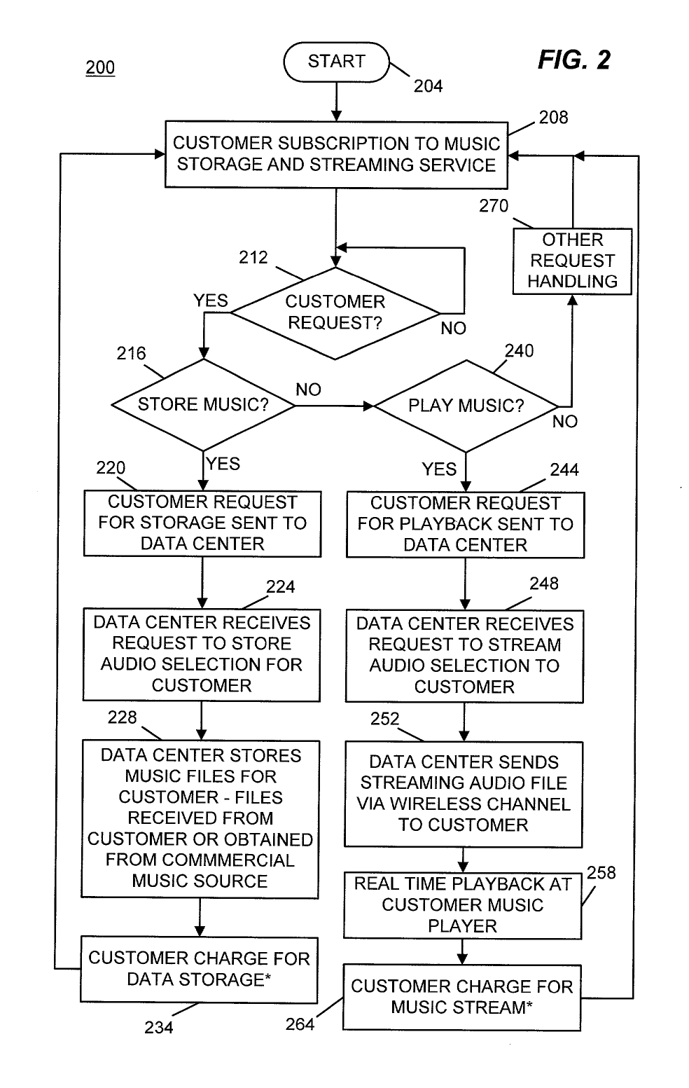

The process described above is illustrated as process 200 of FIG. 2 starting at 204. At 208, a customer subscribes to a music storage and streaming service provided by the data center 108 as illustrated in FIG. 1. From the customer perspective, the services of the data center 108 and the music player 110 are idle until the customer makes a request at 212. If the request is to store music at 216, the customer request for music storage is sent to the data center 108 at 220. The data center 108 receives the request at 224 to store an audio selection for the customer. At 228 the data center 108 stores the music files for the customer. The files can be received either from a customer download or obtained from a commercial music source such as 104. The customer may then (depending upon the subscription arrangement) be charged a fee by the data center 108 based upon the amount of data, or number of files or other criteria for data storage. If such a fee is charged at 234, it is accumulated in the customer subscription for the next billing cycle at 208 and the system awaits the next customer request at 212.

If the request at 216 is not for storage of music files, control passes to 240 to determine if the request is to playback music. If the request is for music playback at 240 the customer request is sent to the data center 108 at 244. The data center 108 receives the request to streaming audio selection to the customer at 248. Assuming the customer request is valid, the data center 108 sends streaming audio files via a wireless channel to the customer at 252. At the music player 110, the music player 110 receives the streaming music file and plays back the music for the customer at 258 in real time or near real time. The customer may again be charged based on usage at 264 (depending upon the subscription arrangement) which is accumulated in the next customer subscription billing cycle at 208. In the event the request at 240 is not for playing music, other request handling such as account management may be handled at 270.

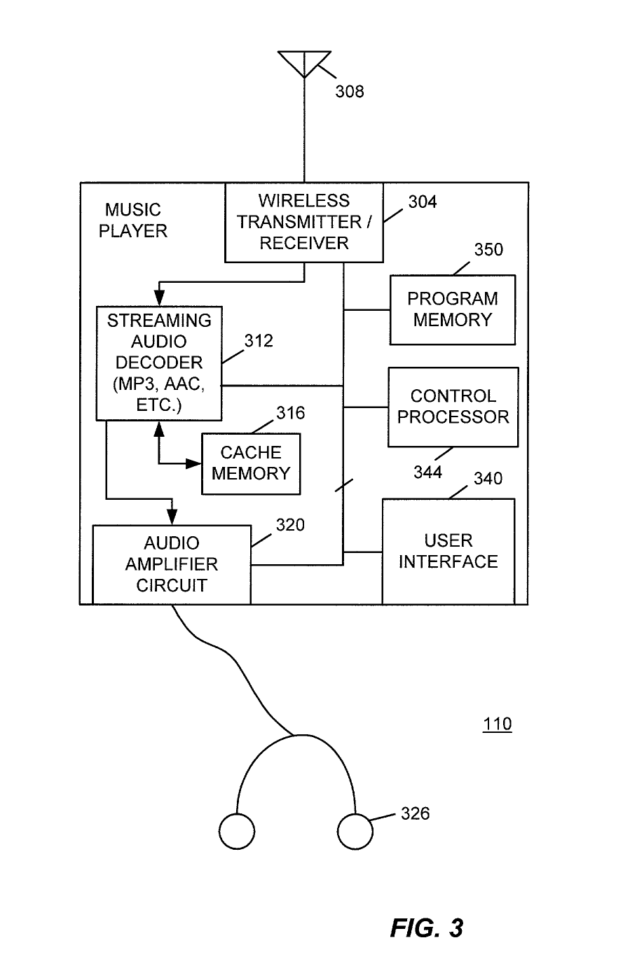

Referring now to FIG. 3, an embodiment of a wireless music player 110 is illustrated. In this embodiment, only the circuitry used for the music player 110 is illustrated. However, those skilled in the art will appreciate that music player 110 may be incorporated within a cellular telephone or other device without departing from the invention. Music player 110 includes a wireless transmitter/receiver 304 that receives and transmits data through an antenna 308. When receiving streaming music data, wireless transmitter/receiver 304 passes received data to a streaming audio decoder 312 for decoding. Streaming audio decoder 312 may decode compressed streaming audio files such as MP3 or ACC files. Streaming audio decoder 312 may incorporate or utilize a separate cache memory 316 to facilitate providing continuous music to the user in the event of momentary dropouts in the wireless transmission. Moreover, streaming audio decoder 312 may be implemented as either hardware or software without departing from the present invention.

Decoded streaming audio from streaming audio decoder 312 is passed to an audio amplifier circuit 320 which in turn drives one or more audio transducers such as those incorporated in headphones 326 to provide the user with audible music. Music player 110 also incorporates a suitable user interface 340 coupled to a control processor 344 such as a microprocessor having associated program memory 350. When the user wishes to control the playback or send a request to the data center 108, the user does so utilizing the user interface 340. Such a request is then processed by the processor 344 and passed on to transmitter portion of all of wireless transmitter/receiver 304 for transmission using antenna 308. Control processor 344 may also be utilized to effect various controls over the wireless transmitter/receiver 304, streaming audio decoder 312 and audio amplifier circuit 320, and may be interconnected thereto, for example, using a multi-wire bus arrangement as illustrated.

Those skilled in the art will appreciate that music player 110 includes a plurality of components that may already be present in some form within various electronic devices such as a PDA or a cellular telephone. In general, streaming audio decoder 312 (implemented as either hardware or software) and modifications to the user interface 340 and a control program stored in program memory 350 could be the major modifications required to certain existing electronic devices in order to implement the present invention.

Those skilled in the art will recognize that the present invention has been described in terms of exemplary embodiments based upon use of a programmed processor within the music player 110 as well as the data center 124. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above, at both the data center 108 and the music player 110, can be implemented using various forms of storage including Read Only Memory (ROM) devices, Random Access Memory (RAM) devices; optical storage elements, disc drives, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and can be stored on any suitable electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method, comprising:
storing a music file for a user;
receiving a request from the user for playback of the music file; and
transmitting the music file to the user for playback, using wireless transmission, as a streaming music file.

2. The method according to claim 1, further comprising:
receiving from the user a request to store the music file; and
wherein the storing is carried out as a response to the request to store the music file.

4. The method according to claim 1, further comprising charging the user a fee for storage of the music file.

5. The method according to claim 1, further comprising charging the user a fee for transmitting the music file to the user.

6. The method according to claim 1, further comprising uploading the music file from the user prior to the storing.

7. The method according to claim 1, further comprising obtaining the music file from a commercial music source prior to the storing.

8. The method according to claim 7, further comprising paying a royalty for use of the music file.

9. An electronic storage medium storing instructions which, when executed on a programmed processor, carry out a method, comprising:
storing a music file for a user;
receiving a request from the user for playback of the music file; and
transmitting the music file to the user for playback, using wireless transmission, as a streaming music file.

10. The electronic storage medium according to claim 9, further comprising:
receiving from the user a request to store the music file; and
wherein the storing is carried out as a response to the request to store the music file.

11. The electronic storage medium according to claim 9, further comprising charging the user a fee for storage of the music file.

12. The electronic storage medium according to claim 9, further comprising charging the user a fee for transmitting the music file to the user.

13. The electronic storage medium according to claim 9, further comprising uploading the music file from the user prior to the storing.

14. The electronic storage medium according to claim 9, further comprising obtaining the music file from a commercial music source prior to the storing.

15. An data center, comprising:
a content server that stores music files for plurality of users;
means for receiving a request from the user for playback of the music file; and
means for transmitting the music file to the user for playback, using wireless transmission, as a streaming music file.

16. The data center according to claim 15, wherein the means for receiving further comprises:
means for receiving from the user a request to store the music file; and
wherein the storing is carried out as a response to the request to store the music file.

17. The data center according to claim 15, further comprising means for charging the user a fee for storage of the music file.

18. The data center according to claim 15, further comprising means for charging the user a fee for transmitting the music file to the user.

19. The data center according to claim 15, further comprising means for uploading the music file from the user prior to the storing.

20. The data center medium according to claim 15, further comprising means for obtaining the music file from a commercial music source prior to the storing.

21. A music player, comprising:
a wireless receiver for receiving transmission of streaming data;
a streaming audio decoder, coupled to the wireless receiver for decoding the streaming data into analog audio signals; and
an audio circuit that converts the analog audio signals into audible sounds.

22. The music player according to claim 21, further comprising:
a user interface that receives user commands; and
a wireless transmitter for transmitting the user commands to a data center to direct the data center to transmit the streaming data.

23. The music player according to claim 21, further comprising a cache memory coupled to the streaming audio decoder for caching the streaming data.

24. The music player according to claim 21, embodied within one of a wireless communication device, a cellular telephone and a personal digital assistant.

25. A method of operation of a wireless music player, comprising:
receiving a user input for playback of a music selection,
transmitting a request to a data center for the music selection;
receiving a streaming data file representing the music selection;
decoding the streaming data file to produce an audible representation of the music selection; and
playing the audible representation of the music selection for the user.

26. The method according to claim 25, wherein the streaming data file is received using a wireless protocol.

27. The method according to claim 26, wherein the wireless protocol comprises Wireless Application Protocol (WAP).

28. An electronic storage medium, storing instructions which, when carried out on a programmed processor carry out a method of operation of a wireless music player, comprising:
receiving a user input for playback of a music selection;
transmitting a request to a data center for the music selection;
receiving a streaming data file representing the music selection;
decoding the streaming data file to produce an audible representation of the music selection; and
playing the audible representation of the music selection for the user.
